(19) United States
(12) Patent Application Publication
(10) Pub. No.: US 2004/0040796 A1
(43) Pub. Date: Mar. 4, 2004

(54) Backing plate with friction material retention members and method and apparatus for manufacturing same

(76) Inventor: Nghi Pham, Concord (CA)

Correspondence Address: PEARNE & GORDON LLP, 1801 EAST 9TH STREET, SUITE 1200, CLEVELAND, OH, 44114-3108, US

(21) Appl. No.: 10/228,605

(22) Filed: Aug. 27, 2002

(51) Int. Cl. F16D 65/38

(52) U.S. Cl. 188/73.37

(57) ABSTRACT

A backing plate for a friction assembly includes a body having a first surface and a second surface. On or more retention members are provided on the first surface for engaging a friction material mounted thereon. Each retention member has a depressed portion and multiple spiral wings extending upwardly in a spiral orientation from the first surface.

### FIELD OF THE INVENTION

This invention relates to friction assemblies suitably used with brakes on vehicles, and more particularly to a backing plate and method and apparatus for manufacturing same.

### BACKGROUND OF THE INVENTION

A friction assembly is a replaceable element in a brake system. In a disk brake, a friction assembly bears against a rotating disc called a rotor. The friction assembly comprises a backing plate to which a friction pad is adhered. The friction pad alone contacts the rotor of the disc brake to provide the stopping frictional force. Significant forces are involved in applying the pad to the rotor, and due to the relative movement during engagement, extreme temperature can be generated up to about 1200° F. Moreover, depending upon the size and/or the payload carried by certain vehicles, the friction assembly bears with significant pressure and vibration when stopping vehicles. It is very important that the backing plate is resistant to bending or breaking due to high pressure, temperature and vibration when stopping vehicles.

Typically, backing plates are modified to include bores, cavities, gouges or protuberances to receive and engage the friction material. These modifications generally improve engagement with a friction material. However, the costs associated with manufacturing backing plates with such modification can often be prohibitive.

It is therefore desirable to provide a backing plate having improved engagement with a friction material without involving undue manufacturing costs.

### SUMMARY OF THE INVENTION

The present invention uses one or more retention members formed on a surface of a backing plate for engaging a friction material. Each retention member comprises a protrusion member with multiple spiral wings extending upwardly in a spiral orientation.

In accordance with an embodiment of the invention, there is provided a backing plate for a friction assembly. The backing plate comprises a body having a first surface for receiving a friction material thereon and a second surface opposed to the first surface; and at least one retention member defined on the first surface, the retention member having a depressed portion and at least one protruding portion adjacent the depressed portion, the protruding portion extending above the first surface in a spiral orientation about the depressed portion.

In accordance with another embodiment of the invention, there is provided a friction assembly for a brake assembly. The friction assembly comprises a body having a first surface and a second surface opposed to the first surface; at least one retention member defined on the first surface, the retention member having a depressed portion and at least one protruding portion adjacent the depressed portion, the protruding portion extending above the first surface in a spiral orientation about the depressed portion; and a friction material mounted on the first surface of the backing plate so that the friction material is engaged with the at least one retention member.

In accordance with another embodiment of the invention, there is provided a method for manufacturing a backing plate. The method comprises steps of forming one or more solid nipples on a first surface of a backing plate material; extruding a wall nip from each solid nipple, the wall nip having a middle depressed portion and a wall around the depressed portion; splitting the wall nip into multiple wings in a spiral orientation about the depressed portion; and flaring the wings outwardly relative to the depressed portion.

In accordance with another embodiment of the invention, there is provided a retention member formation apparatus for forming one or more retention members on a backing plate material. The apparatus comprises a nip forming apparatus and a nip cutting apparatus. The nip forming apparatus forms one or more wall nips on a friction material engaging surface of a backing plate material, each nip having a depressed portion and a wall surrounding the depressed portion. The nip cutting apparatus cuts the wall of each nip into multiple spiral wings in a spiral orientation about the depressed portion, and flares the multiple wings outwardly relative to the depressed portion.

### BRIEF DESCRIPTION OF THE DRAWINGS

For a better understanding of the present invention, and to, show more clearly how it may be carried into effect, reference will now be made by way of example to the accompanying drawings. The drawings show preferred embodiments of the present invention, in which:

FIG. 1 is a perspective view of a friction assembly in accordance with an embodiment of the present invention;

FIG. 2 is a perspective view of a backing plate for the friction assembly of FIG. 1;

FIG. 3 is a sectional view of the backing plate of FIG. 2 taken along line A-A;

FIG. 4 is an enlarge perspective view of a retention member for the backing plate of FIG. 2;

FIG. 5 is a side view of an apparatus for forming one or more retention members in backing plate in accordance with the present invention;

FIG. 6 is a section view of a tool assembly at a step of creating nips on a backing plate;

FIG. 7 is a section view of the tool assembly at a step of protruding cylindrical walls;

FIG. 8 is a section view of protrusions on the plate material at the die opening;

FIG. 9 is a side view of an apparatus for flaring retention members in the backing plate in accordance with an aspect of the present invention;

FIG. 10A is a partial side view of flaring tools at a die open position;

FIG. 10B is a partial side view of flaring tools at a die close position;

FIG. 11 is a schematic side view showing retention members;

FIG. 12 is partial enlarged views of the protruding tool;

FIG. 13 is partial enlarged views of the flaring and cutting tool; and

FIG. 14 is a schematic side view showing a retention member according to another embodiment of the invention.

### DETAILED DESCRIPTION OF THE PREFERRED EMBODIMENTS

An embodiment of the present invention provides a backing plate with one or more retention members for engaging a friction material. Each retention member comprises a protrusion member having with multi-wings extending upwardly and flared out in a spiral orientation like a propeller. The backing plate of this embodiment is intended for use with a disc brake. However, the present invention may be applied to different types of brakes with or without suitable modifications.

FIG. 1 generally shows a friction assembly 20 in accordance with an embodiment of the present invention. Friction assembly 20 includes a friction material 22 and a backing plate 24. Friction material 22 is usually made of phenolic resin with iron powder, steel or carbon fibers, and/or carbon powder. Friction material 22 is mounted on backing plate 24, e.g., molded in known manner to backing plate 24.

Backing plate 24 is formed of metal, a metal composite or such other material that is suitable for the intended use of the friction assembly 20 and that may be processed in accordance with the method described below. Backing plate 24 is of a conventional shape and thickness, and may include apertures and other structural elements known in the art to permit backing plate to be incorporated within a brake assembly (not shown).

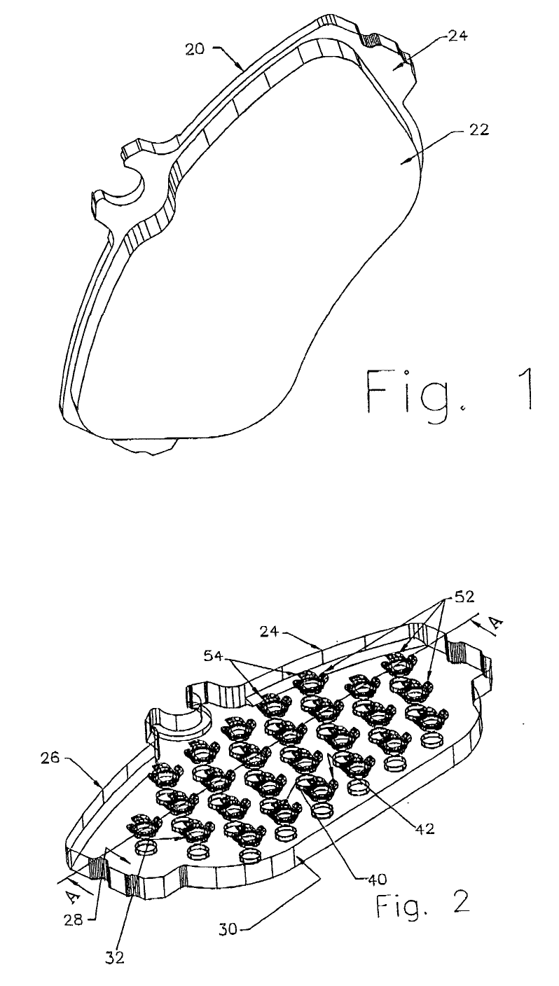

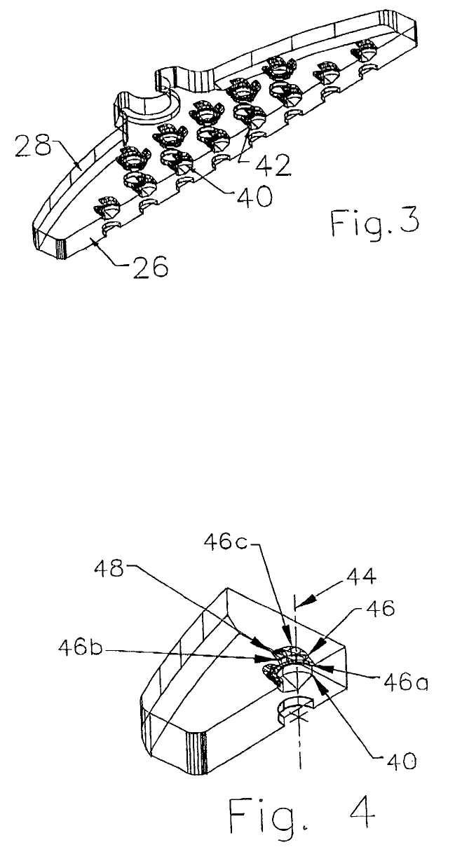

Referring to FIGS. 2-4, backing plate 24 is further described in detail. In these figures, backing plate 24 is shown as if it is transparent for the purpose of illustration, but actual backing plate 24 is typically non-transparent.

Backing plate 24 has a body 26 with a planar top or first surface 28 and an opposing planar bottom or second surface 30. First surface 28 defines one or more retention members 32 for engaging friction material 22 once it has been disposed on first surface 28. First surface 28 preferably defines a plurality of retention members 32.

Each retention member 32 comprises a depressed portion 40 and four protruding portions or wings 42. In this embodiment, depression portion 40 is defined beneath first surface 28 of backing plate 24, i.e., the bottom of depressed portion 40 is lower than first surface 28. The number of the wings and the depth of the depression portion 40 may be varied as described below.

Protruding portions 42 extend above first surface 28. Protruding portions 42 are integrally formed with backing plate 24 from material displaced during formation of depressed portion 40. As best seen in FIG. 4, protruding portions 42 extend like a propeller, i.e., wings 42 extend in a spiral orientation in a clockwise or counterclockwise direction about the central axis 44 of their corresponding depressed portion 40. Each protruding portion 42 typically extends in the spiral orientation for less than one full revolution. Each protruding portion 42 typically has a body 46 with a tip 48. The body 46 has a bottom edge 46a integrally attached to first surface 28, and two generally spiral-shaped sides 46b and 46c merging into the tip 48. Protruding portions 42 preferably have a height of between 0.030-0.075 inches above first surface 28 for backing plates for regular passenger vehicles. For larger vehicles, it is typically desirable to have higher protruding portions 42. Protruding portions 42 may be as high as 0.100 inch.

Retention members 32 are arranged on first surface 28 of backing plate 24 in a density and pattern that provides desired retention of friction material 22 while maintaining desired structural integrity of backing plate 28. Preferably, as shown in FIG. 2, retention members 32 are arranged in rows 52 and columns 54 on first surface 28 with retention members 32 in adjacent rows 52 being arranged in offset columns 54. In a preferred embodiment, retention members 32 are arranged on backing plate 28 with 0.50 inches apart.

On second surface 30 of backing plate 28, recessions 58 may be formed to provide material for forming retention members 32 on first surface 28.

In this embodiment, each retention member 32 has four protrusion members 42. However, in different embodiments, a retention member may have more or fewer protruding portions 42. Typically, more protruding portions 42 on each retention member, stronger the engagement with the friction material against shearing force, as long as each protruding portion 42 is large and strong enough to exhibit the engagement effects.

Also, in this embodiment all retention members 32 have the same number of protruding portions 42 extending in same directions throughout the backing plate 24. However, it is not necessary to provide all same retention members 32. A single backing plate may have different retention members.

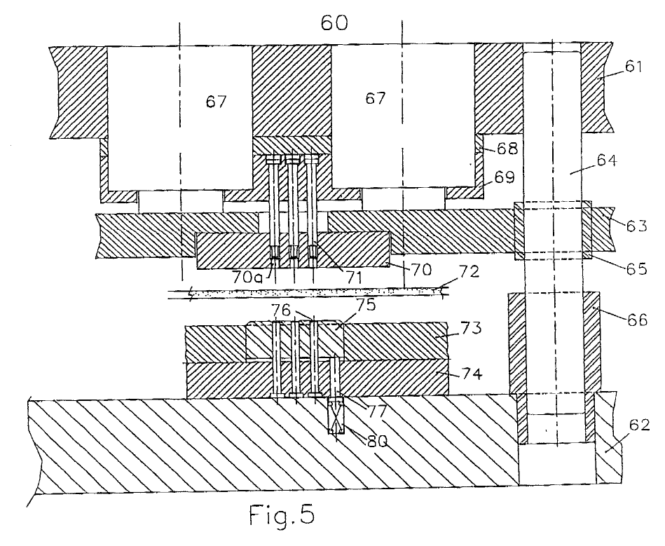

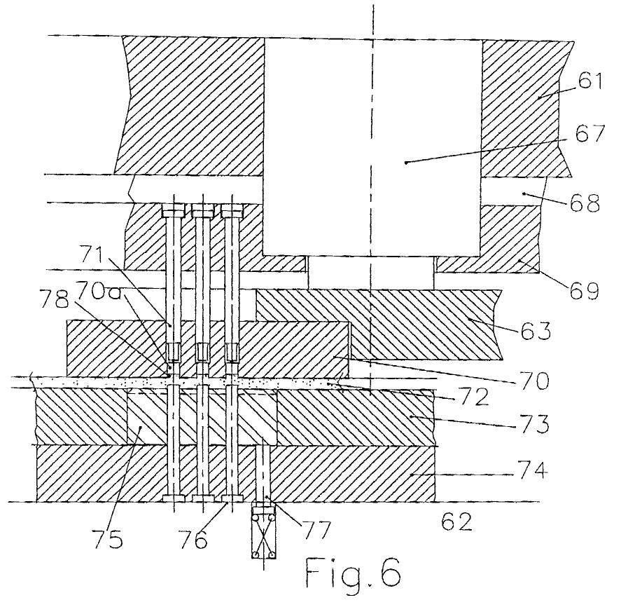

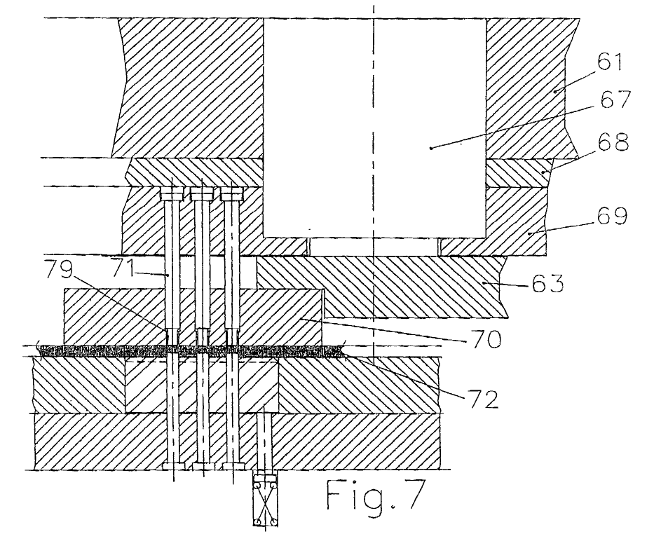

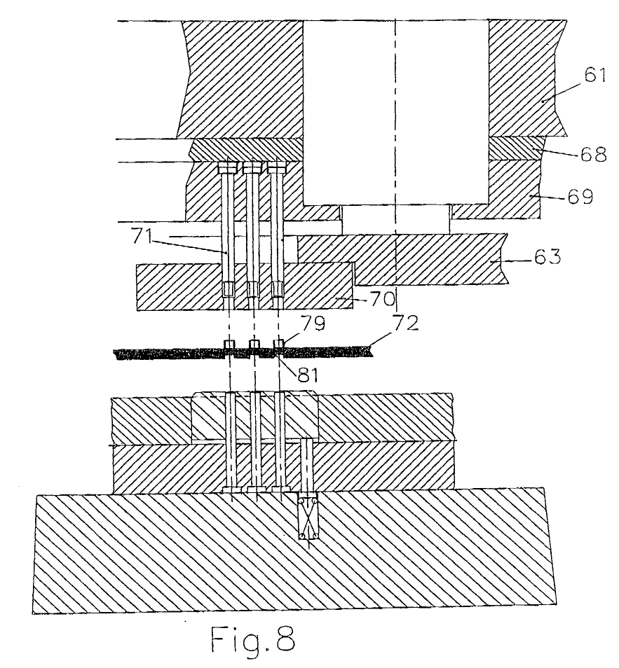

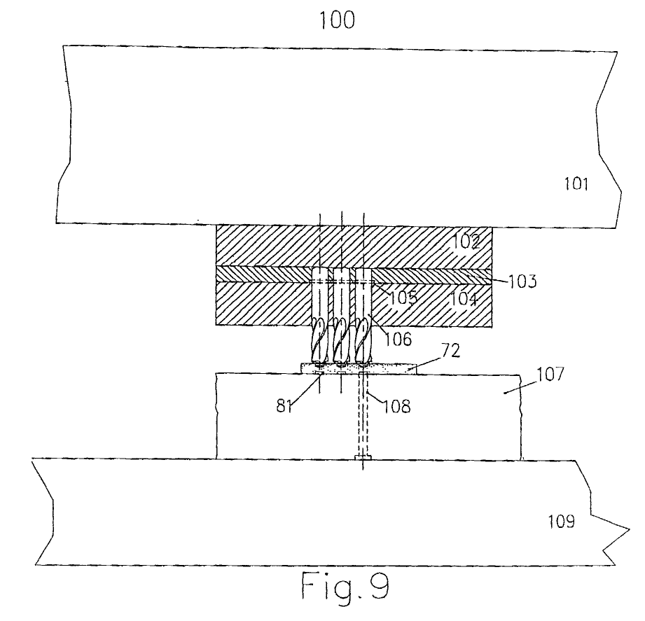

Retention members are preferably manufactured either on a blanked plate or on a strip of incoming material which is being fed into a blanking die. FIG. 5 to FIG. 13 illustrate nip forming apparatus 60 and nip cutting apparatus 100 which are suitably used for a two step operation to manufacture retention members on blanked plates or a strip of material in accordance with an embodiment of the invention.

The two step operation comprises:

Step 1: forming protrusion cylindrical wall nips 79 as shown in FIG. 8.

Step 2: cutting and flaring the cylindrical nips 79 into multiple wings 42 extending in a spiral orientation out of the upper surface of backing plate material 72.

Nip forming apparatus 60 and the first step of forming cylindrical wall nips 79 are described referring to FIGS. 5-8.

Nip forming apparatus 60 comprises a press die having an upper die and a bottom die. The upper die includes upper die shoe 61 which supports protrusion punches 71 through punch holder 69 and back up plate 68. The upper die also has protrusion insert or plate 70 supported by guiding plate 63, which is guided by four pins 64 and bushing 65. Protrusion insert 70 has through holes 70a, each of which slidably receives protrusion punch 71. Guiding plate 63 is spaced apart from punch holder 69 through gas springs 67. Gas springs 67 are supported by upper die shoe 61 for exerting presser on protrusion insert 70 through guiding plate 63. When no pressure exists on upper die shoe 61, the lower punching ends of protrusion punches 71 remain within protrusion insert 70, leaving spaces at lower ends of holes 70a for creation of wall nips 79 within the spaces. When upper die shoe 61 is brought down and guiding plate 63 contacts punch holder 69, protrusion punches 71 slides down within holes 70a for creation of cylindrical wall nips 79, as further described below.

The bottom die includes bottom die shoe 62 that supports die plates 73 and 74. Semi-piercing punches 76 are mounted on lower die plate 74 such that the top ends extend above the upper surface of upper die plate 73. Pressure pad 75 is provided in upper die plate 73 to surround semi-piercing punches 76. Pressure pad 75 is urged up by pins 77 and springs 80 to facilitate separation between semi-piercing punches 76 and backing plate material 72 during the up-stroke of the press.

Referring to FIG. 12 protrusion punch 71 is described in greater detail. Protrusion tool 71 has cylindrical body 201 and head 200 at the upper end of body 201. At the lower end, there are recess section 203, tip 204 and lance 205. On the body 201, there are three flats 202 for oil and/or air vents. There may be more or less number of vents, and the shape of vents may not be flat. Recess section 203 has a smaller diameter than body 201. The diameter of recess section 203 is determined depending on the diameter of hole 70a of protrusion insert 70 and a desired thickness of protruding portions 42.

In the operation of nip forming apparatus 60, backing plate material 72 is fed between the upper and bottom dies (FIG. 5). Backing plate material 72 may be in a form of a blanked plate or a strip of backing plate material. Backing plate material 72 is fed at a predetermined position in conjunction with the stroke cycle of the press. During the down stroke of the press, upper die shoe 61 and its components supported by upper die shoe 61 are moved down.

First, protrusion insert 70 is brought in contact with backing plate material 72 fed on bottom die plate 73. Further pressure brings pressure pad 75 down, and semi-piercing punches 76 push up the sections of backing plate material 72 into hole 70a of protrusion insert 70 to form nipples 78 (FIG. 6). Nipples 78 are solid projections used as material for creating protruding cylindrical wall nips 79 by extrusion.

As the upper die continues moving down, protruding punches 71 are carried down through holes 70a of protrusion insert 70. At the end of the down stroke, protruding punches 71 depress on nipples 78 to force the material to flow upward into the space between recess section 203 of protruding punches 71 and holes 70a of protrusion insert 70 to form cylindrical wall nips 79 (FIG. 7).

The upper die moves up to end the press cycle (FIG. 8). On backing plate material 72, cylindrical wall nips 79 are formed on the upper surface and corresponding recesses 81 are formed on the lower surface. Backing plate material 72 is moved to start a new press cycle or to the next step, as desired.

Referring now to FIGS. 9-11, described are nip cutting apparatus 100 and the second step of cutting and flaring the cylindrical nips 79 into multiple wings 42.

Nip cutting apparatus 100 comprises a press die having an upper die and a bottom die. The upper die includes upper die shoe 101, which holds cutting tools 106 in tool holder 104. Hard plate 102 supports cutting tool 106 from its back. Tool retainer plate 103 with “O” rings 105 prevents cutting tool 106 from falling down, and also allows easy replacement of cutting tools 106.

The bottom die has bottom die shoe 109 that supports die plate 107 with pins 108. Pins 108 are used to position blank plate material 72 at a desired position for the flaring and splitting operation, by mating with recesses 81 created on the lower surface by semi-piercing punches 76 of nip forming apparatus 60.

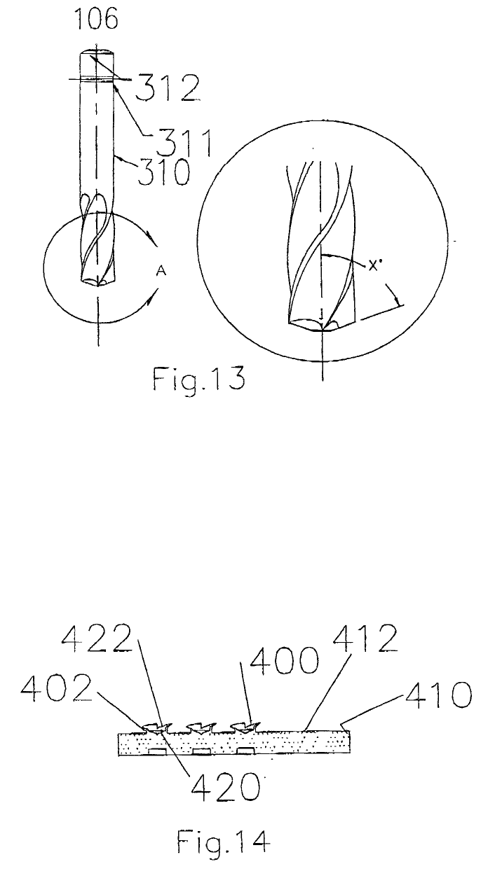

As shown in FIG. 13, cutting tool 106 has a body 310 with cutting edges 109 at the cutting and spiral multi-flutes 110. Spiral multi-flutes 110 continues from cutting edges 109 along the circumference of body 310, which allows splitting of cylindrical nip 79 into multi-portions 80 in a spiral orientation. Body 310 has a diameter larger than that of recess section 203 of protrusion punch 71 of nip forming apparatus 60 to flare cylindrical nip 79. For example, when cylindrical nip 79 is formed using protrusion punch 71 with 0.158 inch-diameter recess section 203, milling cutters 106 of a 0.375 inch-diameter with four flutes 110 may be suitably used. It is preferable that cutting tool 106 has cutting edges 109 at an angle of about 70° in respect to the tool axis. This angle is suitable to flare wall nip 79. The cutting edges 109 are corn shaped with the back angle of 200, which allows multi-portions 80 to flare out. In a different embodiment, the cutting edge angle may be between about 70° and about 90° and the back angle may be between about 20° and about 0°.

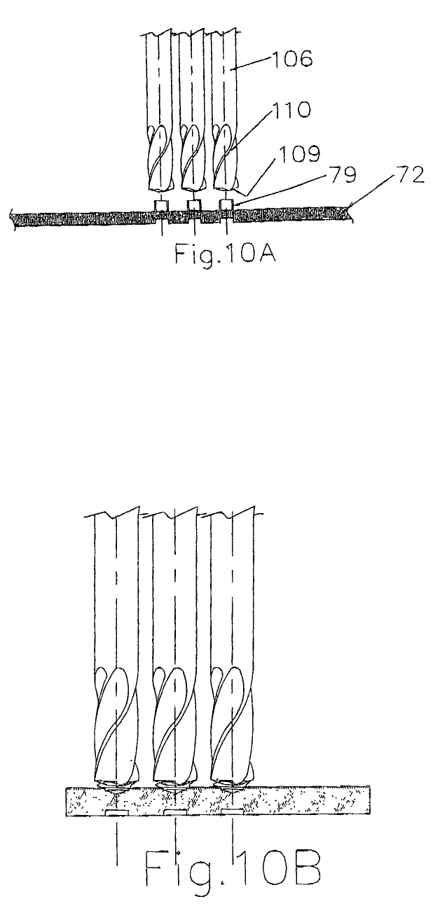

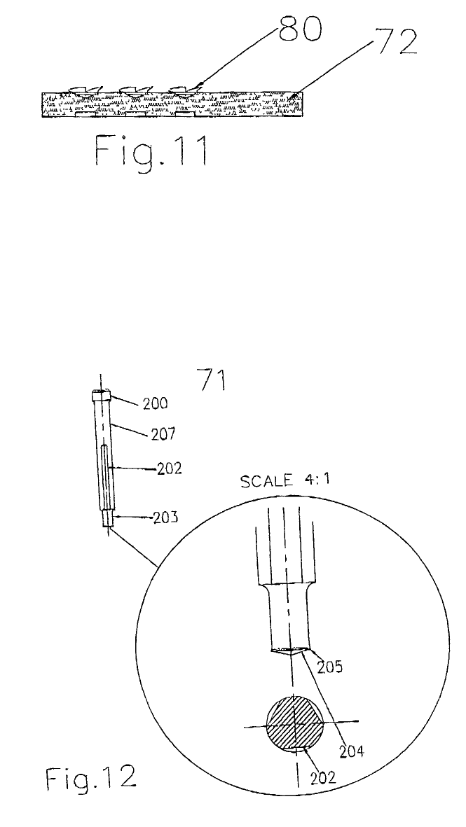

In the operation, during the down stroke of the press, baking plate material 72 with wall nips 79 is fed into the working area between the upper and bottom dies (FIG. 10A). Upper die shoe 101 with its cutting tools 106 moves down to bring cutting edges 109 in contact with protrusion cylindrical nips 79. Further downward movement of upper die shoe 11 causes four cutting edges 109 of cutting tool 106 to split the wall of cylindrical nip 79 into four portions or wings 80. By following the spiral flutes 110, wings 80 are cut in a spiral orientation. As cutting edges 109 are cone shaped, wings 80 are flared out cylindrical nips 79 (FIG. 10B). Upper die shoe 101 then moves up to end the press cycle. Thus, flared protruding portions 80 are formed above the upper surface of backing plate material 72 (FIG. 11).

It is preferable that backing plate material 72 is fed directly from nip forming apparatus 60 to nip splitting apparatus 100 and these apparatus 60 and 100 are operated in a synchronized manner.

In the above embodiments, retention member 32 has depression portion 40 defined beneath first surface 28 of backing plate 24. As shown in FIG. 14, in a different embodiment, retention member 400 may have a stem 402 extending from first surface 412 of backing plate 410, and depression portion 420 may be defined in stem 402 above first surface 412. In this case, protruding portions 422 extend above first surface 412 from stem 402.

Also, in the above embodiments, nips 79 are described to have cylindrical walls. However, nips 79 may have different shapes.

It is to be understood that what has been described is embodiments to the invention. If the invention nonetheless is susceptible to certain changes and alternative embodiments fully comprehended by the spirit of the invention as described above, and the scope of the claims set out below.

What is claimed is:

1. A backing plate for a friction assembly comprising:
a body having a first surface for receiving a friction material thereon and a second surface opposed to the first surface; and
at least one retention member defined on the first surface, the retention member having a depressed portion and at least one protruding portion adjacent the depressed portion, the protruding portion extending above the first surface in a spiral orientation about the depressed portion.

2. A backing plate as claimed in claim 1 wherein the retention member is integrally formed on the first surface.

3. A backing plate as claimed in claim 1 wherein the depressed portion is defined beneath the first surface.

4. A backing plate as claimed in claim 1 wherein the retention member has a stem extending above the first surface, and the depressed portion is defined in the stem.

5. A backing plate as claimed in claim 1 wherein the depressed portion has a central axis and the protruding portion extends in the spiral orientation about the central axis.

6. A backing plate as claimed in claim 1 wherein the protruding portion extends in the spiral orientation for less than one full revolution.

7. A backing plate as claimed in claim 1 wherein the retention member has a plurality of the protruding portions surrounding the depressed portion.

8. A backing plate as claimed in claim 7 wherein the spiral orientation of each of the protruding portions extends in the same direction.

9. A backing plate as claimed in claim 8 wherein the direction of spiral orientation for the protruding portions is a clockwise direction or a counterclockwise direction.

10. A friction assembly for a brake assembly comprising:
a body having a first surface and a second surface opposed to the first surface;
at least one retention member defined on the first surface, the retention member having a depressed portion and at least one protruding portion adjacent the depressed portion, the protruding portion extending above the first surface in a spiral orientation about the depressed portion; and
a friction material mounted on the first surface of the backing plate so that the friction material is engaged with the at least one retention member.

11. A friction assembly as claimed in claim 10 wherein the retention member is integrally formed on the first surface.

12. A friction assembly as claimed in claim 10 wherein the depressed portion is defined beneath the first surface.

13. A friction assembly as claimed in claim 10 wherein the retention member has a stem extending above the first surface, and the depressed portion is defined in the stem.

14. A friction assembly as claimed in claim 10 wherein the depressed portion has a central axis and the protruding portion extends in the spiral orientation about the central axis.

15. A friction assembly as claimed in claim 10 wherein the protruding portion extends in the spiral orientation for less than one full revolution.

16. A friction assembly as claimed in claim 10 wherein the retention member has a plurality of the protruding portions surrounding the depressed portion.

17. A friction assembly as claimed in claim 16 wherein the spiral orientation of each of the protruding portions extends in the same direction.

18. A friction assembly as claimed in claim 17 wherein the direction of spiral orientation for the protruding portions is a clockwise direction or a counterclockwise direction.

19. A friction assembly as claimed in claim 10 wherein the friction material is molded on the first surface of the backing plate.

20. A method for manufacturing a backing plate comprising steps of:
forming one or more solid nipples on a first surface of a backing plate material;
extruding a wall nip from each solid nipple, the wall nip having a middle depressed portion and a wall around the depressed portion;
splitting the wall nip into multiple wings in a spiral orientation about the depressed portion; and
flaring the wings outwardly relative to the depressed portion.

21. The method as claimed in claim 20 wherein the forming step comprises a step of pressing the backing plate material against one or more semi-piercing punches to push portions of the backing plate material from a second surface opposed to the first surface.

22. The method as claimed in claim 20 wherein the extruding step comprises a step of pressing each solid nip to cause material flow to form a wall around the depressed portion.

23. The method as claimed in claim 22 wherein the extruding step is carried out continuously with the forming step.

24. The method as claimed in claim 20 wherein the splitting step comprises a step of pressing a cutting tool having spiral flutes against the wall of each wall nip to split the wall into multiple wings.

25. The method as claimed in claim 24 wherein the flaring step comprises a step of flaring the multiple wings by the cutting tool.

26. A retention member formation apparatus for forming one or more retention members on a backing plate material, the apparatus comprising:
a nip forming apparatus for forming one or more wall nips on a friction material engaging surface of a backing plate material, each nip having a depressed portion and a wall surrounding the depressed portion; and
a nip cutting apparatus for cutting the wall of each nip into multiple spiral wings in a spiral orientation about the depressed portion, and flaring the multiple wings outwardly relative to the depressed portion.

27. The retention member formation apparatus as claimed in claim 26 wherein the nip forming apparatus comprises
one or more semi-piercing punches for pushing portions of the backing plate material from a second surface opposed to the first surface; and
a pressing member for pressing the backing plate material against the semi-piercing punches.

28. The retention member formation apparatus as claimed in claim 27 wherein the nip forming apparatus further comprises one or more depression members, each for pressing each nip to cause material flow to form a wall around the depressed portion.

29. The retention member formation apparatus as claimed in claim 28 wherein the depressing members are provided in connection with the pressing member.

30. The retention member formation apparatus as claimed in claim 26 wherein the nip splitting apparatus comprises
one or more cutting tools, each having cutting edges at a cutting end and spiral flutes continuing from the cutting edges along the length of the cutting tool; and
a pressing member for pressing each cutting tool against the wall of each wall nip to split the wall into multiple spiral wings.

31. The retention member formation apparatus as claimed in claim 30 wherein the cutting edge of each cutting tool has a shape to flare the multiple wings outwardly.
